(19) United States
(12) Patent Application Publication
(10) Pub. No.: US 2016/0221248 A1
(43) Pub. Date: Aug. 4, 2016

(54) Method for laser machining and laser machining apparatus

(71) Applicant: HOMAG HOLZBEARBEITUNGSSYSTEME GMBH, Schopfloch (DE)

(72) Inventors: Christian Compera, Schopfloch (DE); Markus Flik, Schopfloch (DE)

(21) Appl. No.: 15/021,971

(22) PCT Filed: Sep. 12, 2014
(86) PCT No.: PCT/EP2014/069505

§ 371 Date: Mar. 15, 2016

(30) Foreign Application Priority Data
Sep. 16, 2013 (DE) 10 2013 218 483.2

(51) Int. Cl. B29C 59/16

(52) U.S. Cl. CPC B29C 59/16

(57) ABSTRACT

A method for laser machining, as well as a machining apparatus for machining workpieces consisting of wood, derived timber products, or a combination thereof. The method includes the steps of performing on a workpiece a first machining with a first laser machining tool received in an interface, adjusting a laser power density for a second laser machining tool to perform a second machining process, and performing the second machining process with the second laser machining tool, wherein the second machining process differs from the first machining process.

### TECHNICAL FIELD

The present invention relates to a method for laser machining as well as a machining apparatus for machining workpieces preferably consisting of wood, derived timber products, or a combination thereof.

### PRIOR ART

The machining of workpieces of wood or wood-like materials is usually carried out using CNC machining apparatuses having machining tools. In this context, cutting speeds of up to 20 m/min are common.

Furthermore, machining apparatuses are known that have one or more laser units for machining workpieces.

For instance, EP 1 790 447 A1 relates to a method as well as a device for machining plate-shaped workpieces, said workpieces having a first layer preferably consisting essentially of wood, derived timber products, or the like, and a second layer that is harder than the first layer. According to this method, the second layer is first removed using a laser, with the at least one laser and the plate-shaped workpieces being moved relative to each other. Thereafter at least one section of the first layer is removed using a machining tool, in particular a milling device, with the removed section of the first layer being located adjacent to the removed section of the second layer.

Furthermore, DE 299 24 727 U1 is known which shows a machine tool for workpiece machining with machining tools and a laser beam. On the spindle head an ND-Jack laser, which is offset laterally with respect to the central axis of the spindle head, is arranged as a laser beam source, from which a laser beam generated there is guided via a beam guiding channel to a laser head arranged laterally on the milling head and having a scanner system for focusing the laser beam and the guidance thereof across a workpiece surface. Thus, removal of material can, for example, be realised in layers. To perform a machining, a milling or drilling tool can be inserted into the work spindle, for example.

Another device is known from DE 10 2011 002 696 A1 which relates to the machining of, e.g., derived timber products, having a radiation device for generating and/or transmitting radiation, and a spindle unit having a shaft rotatable in a shaft bearing section, and a holder for machining tools and/or machining units. The shaft and/or a unit attached to the shaft have, at least in sections, a cavity, and the radiation device is arranged such that the radiation extends, at least in sections, inside the cavity.

The Subject Matter of the Invention

The aim of the present invention is to provide a method and a machining apparatus with which laser energy used for machining workpieces can be applied more variably.

The subject matter of claim 1 provides a method fulfilling these requirements. Further embodiments are described in the dependent claims.

The core idea of the present invention is to provide a method and a machining apparatus using a laser source and to make the energy provided by the laser source usable for various machining operations.

Said machining operations may be a removing or separating machining. As an alternative, it may also be provided to activate an adhesive agent layer of a coating material with the energy provided by the laser beam, or to heat a section of a workpiece or a coating material. The latter may be used to change the material properties and to thus prepare the workpiece or the coating material for a subsequent machining.

In particular, the present invention relates to a method for machining e.g. plate-shaped or strip-shaped workpieces preferably consisting of wood, derived timber products, plastics, or the like. The method comprises the following steps: performing on a workpiece a first machining with a first laser machining tool received in an interface, adjusting the laser power density, in particular at the point of machining, for a second laser machining tool, performing a second machining with the second laser machining tool, with the second machining differing from the first machining.

Thus, a method is provided with which various laser machinings can be carried out without providing additional laser sources for different machining operations. This increases the flexibility within a production process without increasing the costs.

The first and second machinings are preferably selected from a cutting machining, an activation of an adhesive agent, a drilling machining, a welding machining, and a trimming machining.

Preferably, the first and second laser machining tools are used on the same workpiece such that the first machining and the second machining are performed on this workpiece. For example, in a first step, an adhesive agent of an edge material can thus be activated on a workpiece using laser energy, and the edge material can be glued to a narrow surface of this workpiece. In a second step, the edge protruding at an end of the workpiece is then trimmed using laser energy.

The aforementioned adjustment of the laser power density particularly comprises a change of the laser power density and/or the optical parameters, in particular focusing. The laser power density in the machining area is accordingly adjusted to a specific machining. For instance, with separating machining operations, higher powers are necessary than when activating an adhesive agent on a coating material.

In one embodiment of the present invention, the first laser machining tool is removed from the interface after completion of the first machining, and the further laser machining tool is inserted into the interface. In this manner, the variability of the method can be increased by the aforementioned replaceability, without providing separately arranged and, where necessary, separately movable laser machining tools.

The present invention is furthermore directed at a machining apparatus suitable for performing the aforementioned methods. The machining apparatus comprises: a workpiece support for receiving and, where necessary, holding workpieces during machining, an interface and a laser machining tool received thereon, and a laser source and a laser guiding path for guiding the laser energy provided by the laser source from the laser source to the laser machining tool. The apparatus is characterised in that it comprises a laser power density adjusting unit to adjust the laser power density available for machining.

Said interface is preferably attached to a guiding device, in particular a portal or a side-arm. Accordingly, the laser machining tool received at the interface can be displaced.

The laser source is preferably a diode laser, a fibre laser, a solid-state laser, or an Nd-YAG laser.

The laser guiding path preferably has a beam switch and/or beam splitters with which the laser beam can be guided to different interfaces via different laser guiding path arms. Thus, a laser source can be used to provide laser energy for a machining at different sections of a machining apparatus.

In a preferred embodiment, the interface receives a laser beam unit, a unit for processing a coating material, e.g. activating an adhesive agent layer of a coating material, a laser drilling unit, a laser welding unit, or a laser trimming unit. Each of said units can preferably be inserted into the interface, as a result of which the variability of the apparatus is considerably increased.

In addition to said laser machining tool, the machining apparatus may comprise a machining tool, in particular a milling or drilling device, in a unit. During the machining of a workpiece, this can be integrated in the machining operation with the laser machining tool such that the machining options of the machining apparatus are increased.

In one embodiment of the present invention, the workpiece support comprises vacuum suction cups to be able to hold a workpiece. In other variants of the present invention, a belt or roller conveyor is provided to achieve a relative movement between the laser machining tool and the workpiece.

In addition to the laser machining tools, a further energy source may be provided that is selected from the group consisting of laser, infrared source, ultrasound source, magnetic field source, microwave source, plasma source, and gassing source. This energy source can cooperate with the laser machining tools or pre-treat or post-treat the area to be machined by these. In the case of pre-treatment, the area to be machined by the laser machining tools is pre-heated, for example. In the case of post-treatment, a temperature can be specifically set and maintained over a defined area after the treatment by the laser machining tools.

### BRIEF DESCRIPTION OF THE DRAWINGS

FIG. 1 shows a schematic view of an embodiment of the machining apparatus according to the invention.

### PREFERRED EMBODIMENTS

The machining apparatus comprises a laser source 1 which guides a laser energy through a laser guiding path 2. In the area of the laser guiding path 2, a beam switch 3 is provided with which the laser beam can be directed in a first laser guiding path arm 2a or a second laser guiding path arm.

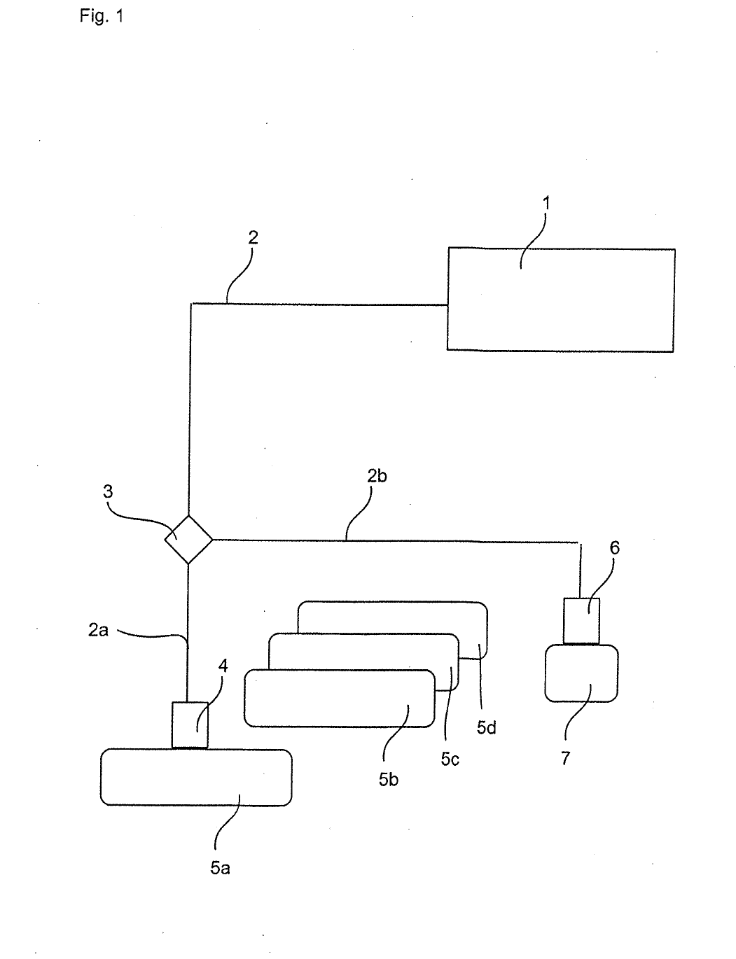

The first laser guiding path arm 2a is connected to an interface 4 at which a laser machining tool 5a is received. Furthermore, several laser machining tools 5b-5d are shown in FIG. 1, which are held available in a replacement system and can be inserted into the interface 4.

In the area of the machining apparatus a second interface 6 is provided which is supplied, starting from the beam switch 3 via the second laser guiding path arm 2b, with the energy of the laser beam generated in the laser source 1. A further laser machining tool 7 is received in the interface 6.

Thus, a first machining using the laser machining tool 5a can be carried out with the machining apparatus shown. Thereafter, the laser machining tool 5a is removed from the interface 4 and replaced with another laser machining tool 5b-5d. Since the laser machining tool 5b-5d performs a different machining than does the laser machining tool 5a, the laser power density is adjusted, in particular changed, before it is used. Subsequently, a second machining is carried out with the laser machining tool 5b-5d, which second machining differs from the first machining.

It may be provided that the respective laser machining tool has a signature with which the adjustment of the laser power density is recognised upon insertion into the interface and set by the machining apparatus.

Alternatively to a replacement of the laser machining tool 5a, it is also possible to guide the laser beam into the second laser guiding path arm 2b via the beam switch 3, thus providing the laser machining tool 7 with energy. In this manner, a flexible switch can be made between the laser machining tool 5a and the laser machining tool 7. Since both tools usually perform a different machining, the laser power density is adjusted, in particular changed, before the respective other laser machining tool is used.

If a CO2 laser is in a cutting machining for a cutting depth of 3 mm in an HDF board with cutting speeds of up to 30 m/min, a laser power density of 2,122,066 W/cm2 can be achieved with a laser power of 1500 W and a circular spot diameter on the workpiece of 0.3 mm (surface spot area=0.00071 cm2). If, however, a rectangular spot diameter on the workpiece of 5×15 mm (surface spot area=0.75 cm2) is selected by inserting a different laser machining tool, a laser power density of 2,000 W/cm2 is achieved with the same laser power. This can be used, for example, for activating an adhesive agent on an edge band.

In the area of the interface for the laser machining tool a lower laser power density is chosen. This means that the optics in the area of the interface is designed so as to be wider than the laser guiding path. Thus, the interface becomes more insensitive to foreign objects that can settle thereon in a dusty environment.

1. A method for machining a plate-shaped or strip-shaped workpiece comprising, wood, derived timber products, or plastic, the method comprising the steps of:
performing on the workpiece a first machining with a first laser machining tool received in an interface,
adjusting a laser power density for a second laser machining tool for performing a second machining, and
performing the second machining with the second laser machining tool, wherein the second machining differs from the first machining.

2. The method according to claim 1, characterised in that the first and second machinings are selected from the group consisting of a cutting machining, an activation of an adhesive agent machining, a drilling machining, a welding machining, and a trimming machining.

3. The method according to claim 1, characterised in that the first machining and the second machining are performed on the same workpiece.

4. The method according to claim 1, characterised in that the adjustment of the laser power density comprises a change of the laser power and/or optical parameters.

5. The method according to claim 1, characterised in that after completion of the first machining, the first laser machining tool is removed from the interface and the second laser machining tool is inserted into the interface.

6. A machining apparatus for performing the method according to claim 1, wherein the machining apparatus comprises:
a workpiece support for receiving, holding, and for transporting the workpiece during machining,
the interface and the laser machining tool received thereon,
a laser source and a laser guiding path for guiding laser energy provided by the laser source from the laser source to the laser machining tool,
characterised in that
the machining apparatus further comprises a laser power density setting unit to adjust the laser power density available for machining.

7. The machining apparatus according to claim 6, characterised in that the interface is attached to a guiding device.

8. The machining apparatus according to claim 6, characterised in that the laser source is selected from the group consisting of a diode laser, fibre laser, a solid-state laser, a Nd-YAG laser, a gas laser, and a CO2 laser.

9. The machining apparatus according to claim 6, characterised in that the laser guiding path comprises a beam switch and/or a beam splitter with which the laser beam can be guided to different interfaces via different laser guiding path arms.

10. The machining apparatus according to claim 6, characterised in that the interface receives a unit selected from the group consisting of a laser cutting unit, a unit for processing a coating material, a laser drilling unit, a laser welding unit, and a laser trimming unit.

11. The machining apparatus according to claim 10, characterised in that the unit can be inserted into the interface.

12. The machining apparatus according to claim 6, characterised in that the machining apparatus comprises a multi-axis unit, having a a milling or drilling device.

13. The machining apparatus according to claim 6, characterised in that the workpiece support is selected from the group consisting of vacuum suction cups, a belt and a roller conveyor.

14. The machining apparatus of claim 6 characterised in that the interface is attached to a portal or a sidearm.

15. The machining apparatus of claim 6 characterized in that the machining apparatus comprises a unit having a machining tool.
